(19) United States
(12) Patent Application Publication
(10) Pub. No.: US 2009/0294608 A1
(43) Pub. Date: Dec. 3, 2009

(54) Mounting Structure

(76) Inventor: Paul Brassard, Arcadia, CA (US)

Correspondence Address: JAMES E. BRUNTON, ESQ., P. O. BOX 29000, GLENDALE, CA, 91209, US

(21) Appl. No.: 12/130,813

(22) Filed: May 30, 2008

(51) Int. Cl. F16B 47/00

(52) U.S. Cl. 248/205.5

(57) ABSTRACT

An improved mounting structure for mounting objects, such as PDAs, Palm devices, and like electronic components within a vehicle. The mounting structure includes a uniquely designed two piece mounting arm to which a specially designed mounting plate is connected which can be used in interconnecting an object connector plate with the improved mounting structure.

### BACKGROUND OF THE INVENTION

### Field of the Invention

The present invention relates generally to mounting structures for supporting articles especially within vehicles. More particularly the invention concerns an improved mounting structure for mounting electronic devices which comprises a mounting plate having a pair of uniquely configured, spaced-apart connector elements that are designed to be used in interconnecting a selected object connector plate with the improved mounting structure.

### SUMMARY OF THE INVENTION

It is an object of the present invention to provide an improved mounting structure for mounting objects, such as PDAs, Palm devices, and like electronic components within a vehicle. More particularly it is an object of the invention to provide such a mounting structure which includes a uniquely designed two piece mounting arm to which a novel mounting plate is connected that can be used in interconnecting an object connector plate with the improved mounting structure.

Another object of the invention is to provide an improved mounting structure of the aforementioned character in which the mounting plate is connected to the two piece mounting arm or swiveling movement with respect thereto.

Another object of the invention is to provide an improved mounting structure as described in the preceding paragraphs in which the mounting plate is provided with a pair of spaced-apart, uniquely-shaped connector elements that can be securely mated with connector elements provided on the object connector plate.

Another object of the invention is to provide an improved mounting structure of the character described in which the improved mounting plate provides a more secure fit with the object connector plate than was possible with prior art constructions.

Another object of the invention is to provide an improved mounting structure of the class described in which the improved mounting plate provides a reliable, robust interconnection between the mounting plate and the object connector plate to which the object to be mounted is secured.

Another object of the invention is to provide an improved mounting structure of the character described in which the improved mounting plate is provided with uniquely designed connector elements that snugly receive connector elements on the object connector plate so that play between the object connector plate and the improved mounting structure is minimized.

Another object of the invention is to provide an improved mounting structure which includes novel release means for releasing the suction on the suction-type connector of the mounting structure.

Another object of the invention is to provide an improved mounting structure that is compact, easy to use, comprises a minimum number of cooperating components and is economical to manufacture in large quantities.

### BRIEF DESCRIPTION OF THE DRAWINGS

FIG. 1 is a generally perspective top view of one form of the improved mounting structure of the present invention.

FIG. 2 is a side elevational view of the improved mounting structure shown in FIG. 1.

FIG. 3 is a front view of the improved mounting structure shown in FIG. 1.

FIG. 4 is a generally perspective, exploded view of the improved mounting structure shown in FIG. 1.

FIG. 5 is a cross-sectional view taken along lines 5-5 of FIG. 3.

FIG. 6 is a cross-sectional view taken along lines 6-6 of FIG. 5.

FIG. 7 is a generally perspective, exploded view of one form of the mounting plate and object connector plate of the invention, the mounting plate being partly broken away to showing internal construction.

FIG. 8 is an exploded, side-elevational, cross-sectional view of the mounting plate and object connector plate shown in FIG. 7.

FIG. 9 is a side-elevational, cross-sectional view of the mounting plate and object connector plate as the components appear when in the position to be moved into an interlocking configuration.

FIG. 10 is a side-elevational, cross-sectional view showing the mounting plate and connector plate in an interconnected configuration.

FIG. 11 is a generally perspective, exploded view of an alternate form of mounting plate and object connector plate of the invention, the alternate form of mounting plate being partly broken away showing internal construction.

FIG. 12 is an exploded, side-elevational, cross-sectional view of the alternate form of mounting plate and object connector plate shown in FIG. 11.

FIG. 13 is a side-elevational, cross-sectional view of the alternate form of mounting plate and object connector plate as the components appear when in the position to be moved into an interlocking configuration.

FIG. 14 is a side-elevational, cross-sectional view showing the alternate form of mounting plate and connector plate in an interconnected configuration.

FIG. 14A is a side-elevational, cross-sectional view showing the alternate form of mounting plate interconnected with the connector plate in an inverted configuration from that shown in FIG. 14.

### DESCRIPTION OF THE INVENTION

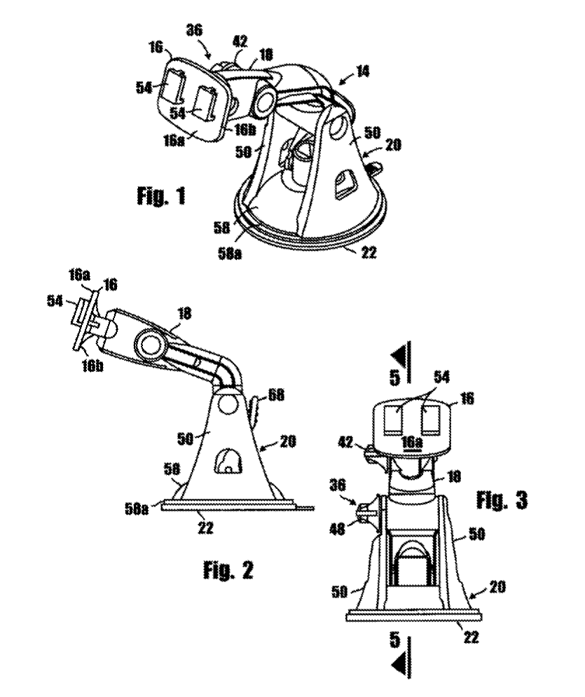

Referring to the drawings and particularly to FIGS. 1, 2 and 3, one form of the improved mounting structure of the present invention for use with a selected object connector plate is there illustrated and generally designated by the number 14.

As shown in FIG. 1, the improved mounting plate 16 is interconnected with the first end of a novel, two piece elongated arm assembly 18 by connector means, the details of construction of which will presently be described. Connected at the opposite, or second, end of the arm assembly 18 is a suction-type connection mechanism 20 that includes a suction cup component 22 that is designed to be removably attached to a smooth surface, such as the windshield of a conventional vehicle. As will presently be described, connector mechanism 20 includes a novel suction forming and release mechanism for forming and releasing suction developed by a suction cup 22.

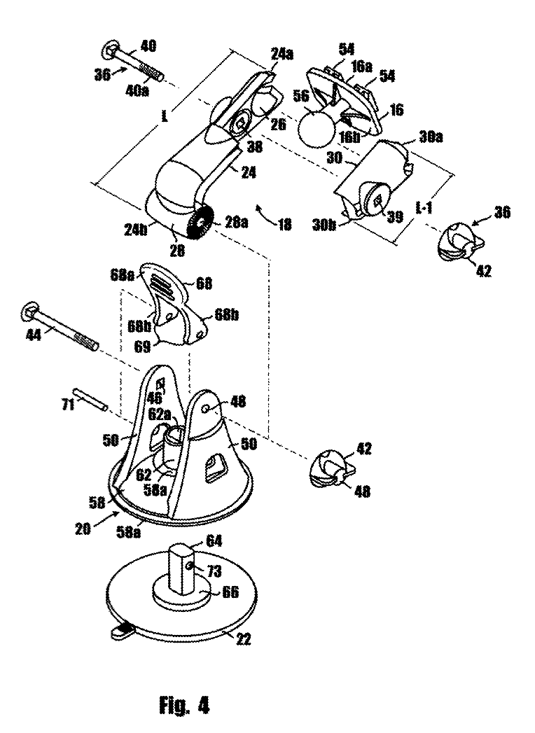

As best seen in FIG. 4, elongated arm assembly 18 here comprises a unitary first arm portion 24 having a first length “L” and first and second ends 24a and 24b. First end 24a is provided with a generally hemispherical shaped cavity 26 and second end 24b includes a generally cylindrically shaped connector member 28 having a transversely extending bore 28a.

Elongated arm assembly 18 also includes a unitary second arm portion 30 that, in a manner presently to be described, is adjustably connected to first arm portion 24 for movement between a first closed position and a second open position. Second arm portion 30 has first and second ends 30a and 30b respectively and is of a second length “L-1” that is substantially less than the first length “L” of the first arm portion 24. First end 30a, like first end 24a, is provided with a generally hemispherical shaped cavity 32 (FIG. 6). Connected to first and second arm portions 24 and 30 for moving the second arm portion 30 toward its first closed position is a tightening mechanism generally designated in the drawings by the numeral 36.

As illustrated in FIG. 4 of the drawings, first and second arm portions 24 and 30 are provided with coaxially aligned apertures 38 and 39 and the tightening mechanism 36 here comprises an elongated bolt 40 having a threaded end 40a. As shown in FIG. 4, elongated bolt 40 is received within the coaxially aligned apertures 38 and 40 and a thumbscrew 42 is threadably interconnected with the threaded end 40a of the elongated threaded bolt. Tightening thumbscrew 42, which comprises a part of the tightening mechanism of the invention, functions to controllably move the second arm portion 30 toward its first closed position shown in FIG. 6 of the drawings.

As previously mentioned, the suction-type connection mechanism 20 which includes a suction cup component 22 is connected at the second end of the arm assembly 18. More particularly, the suction-type connection mechanism 20 is connected to generally cylindrically shaped connector member 28 of first arm portion 24 by means of a threaded tightening bolt 44. Tightening bolt 44 is received within apertures 46 and 48 formed in a pair of spaced apart sidewalls 50, which form a part of connection mechanism 20 and within transversely extending bore 28a. Connected to tightening bolt 44 is a threaded thumbscrew 48 which when tightened against one of the sidewalls 50, functions to secure arm assembly 18 against pivotal movement relative to the sidewalls 50. However, when the thumbscrew is loosened, arm assembly 18 can be pivotally adjusted relative to sidewalls 50 to position arm assembly 18 in the desired position.

As previously mentioned, the object mounting structure of the invention which comprises the mounting plate 16 is secured between the first and second arm portions 24 and 30 for swiveling movement with respect thereto. As best seen in FIG. 4, mounting plate 16 has a generally planar upper surface 16a and a lower surface 16b. Connected to upper surface 16a and extending therefrom is a pair of spaced-apart connector elements 54.

Connected to lower surface 16b and extending there from, is a generally spherical shaped connector member 56. As illustrated in FIG. 6 of the drawings, generally spherical shaped connector member 56 is receivable within the generally hemispherical shaped cavities 26 and 32 provided in the first and second arm portions for swiveling movement there within between first and second positions. It is apparent that by tightening thumbscrew 42 relative to threaded bolt 40 arm portion 30 can be moved into clamping engagement with the spherical shaped connector member 56 so as to preclude swiveling movement of the connector member within the cavities 26 and 32. Conversely, when it is desired to reposition mounting plate 16, thumbscrew 42 can be loosened in a manner to cause sufficient separation between the first and second arm portions so as to permit swiveling movement of the spherical shaped connector member 56.

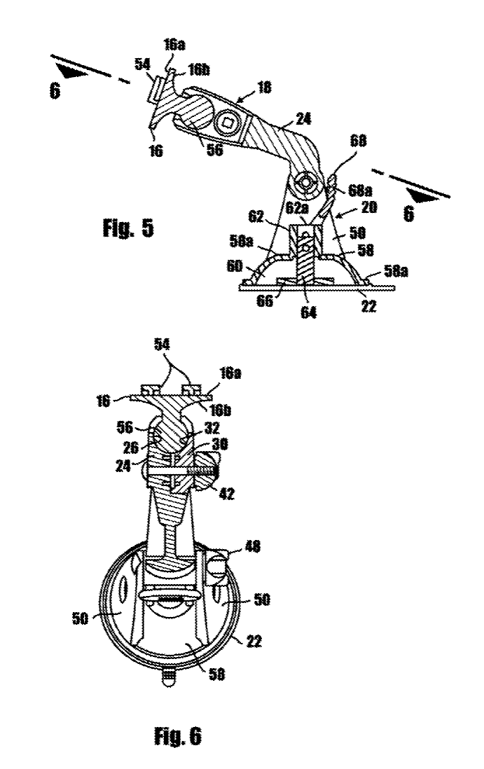

As best seen by referring to FIGS. 4 and 5, suction cup 22 is carried by a housing 58 having a flange portion 58a. Housing 58 is provided with concave cavity 60 and an upstanding central portion 62 having an axial passageway 62a within which a drive member 64 reciprocates (FIG. 5). When a vacuum is formed by the suction forming mechanism of the invention, the central portion of suction cup 22 is received within concave cavity 60 of the housing. Drive member 64 is interconnected with central portion of the suction cup by a connector flange 66 and is movable by a pivotally mounted lever member 68 from a first retracted position to a second extended position.

As best seen in FIG. 4, lever member 68, which is generally yoke-shaped, has a finger engaging portion 68a and a pair of spaced-apart outwardly extending arms 68b, each of which includes a cam-like extremity 69 that bears against a flange 58a of the housing 58. Arms 68b are apertured to receive a transversely extending connector pin 71 that extends through a bore 73 provided in drive member 64 and functions to interconnect lever member 68 with the drive member 64. With this construction, when the lever member is moved pivotally downward, the drive member 64 along with the central portion of the suction cup 22 will also move upwardly causing a suction to be formed which will hold the supporting structure securely in position on the vehicle windshield. When it is desired to remove the supporting structure from the vehicle windshield and to break the vacuum holding it in position, a pressure exerted against the finger engaging portion 68a of lever member 68 will cause the lever member to pivot into a downward position. This downward movement of lever member 68 will cause the cam-like extremities 69 of the arms to bear against flange 58a in a manner to cause drive member 64 to move downwardly thereby releasing the vacuum formed within the vacuum cup 22.

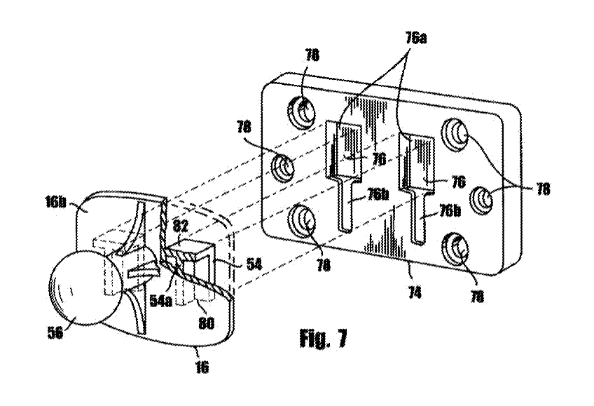

Considering now the construction of the improved mounting plate 16 and its interaction with the object connector plate 74 of the invention. As illustrated in FIGS. 7, 8, 9 and 10, each of the connector elements 54 of the improved mounting plate 16 is provided with an upstanding connector segment 54a. “T”-shaped connector segments 54a are lockably received within spaced-apart cavities 76 formed in the article connector plate 74. Plate 74, which is illustrated in FIG. 7, is provided with a plurality of spaced-apart apertures 78 to permit the connector plate to be interconnected with various types of cradles (not shown) for supporting articles such as, for example, cell phones, PDA's, handheld computers and like devices.

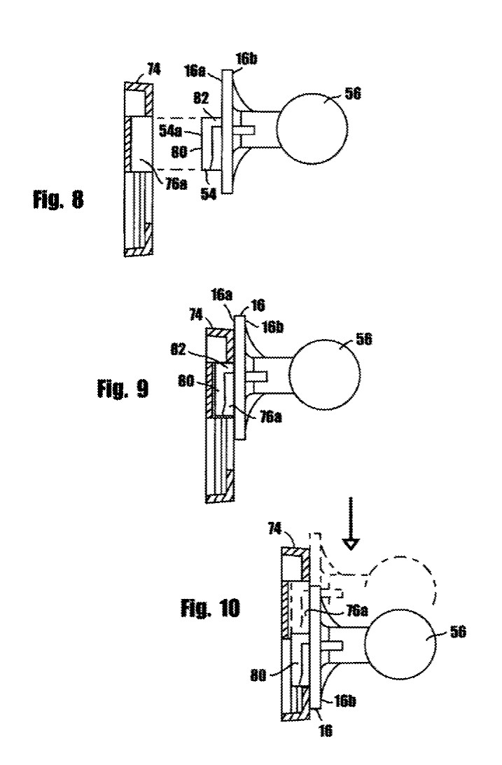

During the step of interconnecting the object connector plate 74 with the mounting plate 16, the connector plate 74 is first moved from the position shown in FIG. 8 into the position shown in FIG. 9 wherein the connector elements 54 of the mounting plate are moved into the upper portions 76a the cavities 76 of the article connector plate 74. This done, the mounting plate is moved from the configuration shown in the dotted lines in FIG. 10 into the position shown by the solid lines in FIG. 10. During this movement, the central beam portions 80 of the locking segments of the mounting plate will slide into the elongated slot portions 76b of the cavities 76 formed in the connector plate 74 (FIG. 7) and will be securely locked in position by the top wall portions 82 that are integrally formed with central beam portions 80. With the novel construction thus described, the uniquely designed connector elements 54 of the connector plate are snugly received within the mating cavities of the object connector plate 74 so that play between the object connector plate and the improved mounting plate is minimized. Additionally, the spaced-apart connector elements positively resist any rotational movement between the object connector plate and the mounting plate. It is these important features that are lacking in the single connector element construction of the prior art devices.

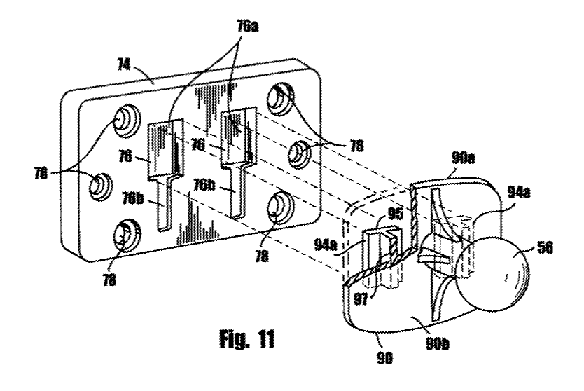

Turning next to FIGS. 11, 12, 13, 14 and 14A an alternate form improved mounting plate is there shown and generally designated by the 90. Mounting plate 90 is similar in many respects to the earlier described mounting plate 16 and like numerals are used in FIGS. 11 and, 12, 13, 14 and 14A to describe like components. In a manner presently to be described, mounting plate 90 interacts with the object connector plate 74 of the invention in a generally similar way. The primary difference between this latest embodiment of the invention and the earlier described invention resides in the fact that the differently configured connector elements 94 of the improved mounting plate 90 can be connected to the object connector plate 74 in two directions. More particularly, as best seen in FIG. 11 of the drawings, each of the connector elements 94 of the improved mounting plate 90 is provided with an upstanding, generally “T”-shaped connector segment 94a. “T”-shaped connector segments 94a are lockably received within the spaced-apart cavities 76 formed in the article connector plate 74, which is of identical construction and operation to that previously described. Connector segments 94a include a base portion 95 and an upstanding segment 97 that is integrally formed with base portion 95 (FIG. 11).

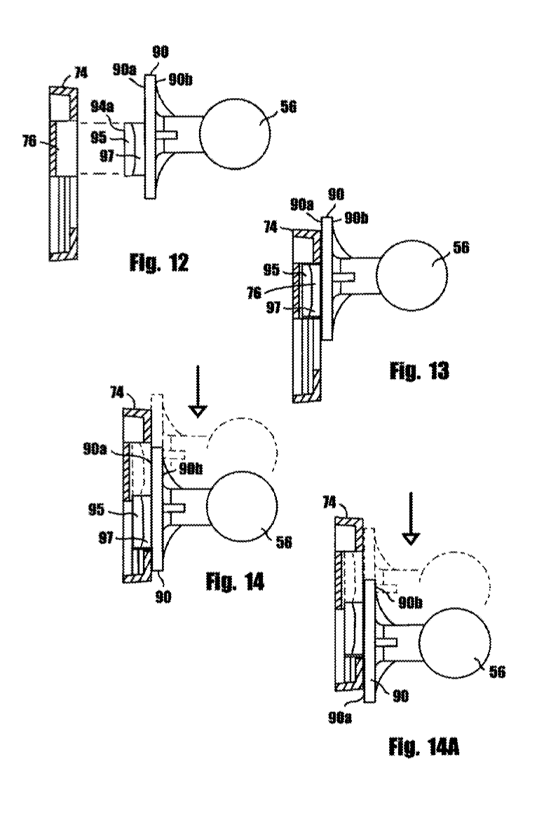

Referring now to FIGS. 12, 13 and 14, during the step of interconnecting the object connector plate 74 with the mounting plate 90, the connector plate is moved from the position shown in FIG. 12 into the position shown in FIG. 13 wherein the open-ended connector elements 94 of the mounting plate are moved into the upper portions 76a of the cavities 76 of the article connector plate. Next, the mounting plate is moved, from the position shown in FIG. 13 into the locked position shown in FIG. 14. With the novel construction thus described, the uniquely designed connector elements 94 of the connector plate are snugly received within the mating cavities of the object connector plate 74 so that play between the object connector plate and the improved mounting plate is minimized. Additionally, the spaced-apart connector elements positively resist any rotational movement between the object connector plate and the mounting plate.

As previously discussed, because of the novel construction of the open-ended connector elements 94, the mounting plate can be interconnected with the object connector plate in a first upright position shown in FIG. 14, or alternatively, if desired, in and inverted position shown in FIG. 14A.

With the mounting plate connected to the connector plate, either in the upright position or in the inverted position, by using the suction cup mechanism, the assemblage can be connected to the vehicle windshield in the manner previously described.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A mounting structure for supporting objects within a vehicle comprising:
(a) an elongated arm assembly comprising:
(i) a first arm portion having first and second ends, said second end including a generally cylindrically shaped connector member;
(ii) a second arm portion adjustably connected with said first portion for movement between a first closed position and a second open position, said second arm portion having first and second ends, said first ends of said first and second portions cooperating to define a receiving socket;
(b) a suction-forming connecting assembly connected to said generally cylindrically shaped connector member of said first arm portion of said elongated arm assembly for pivotal movement with respect thereto between a first position and a second position, said suction type connecting assembly being designed to be removably attached to a smooth surface; and
(c) an object mounting structure secured between said first and second arm portions of said elongated arms for swiveling movement with respect thereto.

2. The mounting structure as defined in claim 1 in which said first arm portion has a first length and in which said second arm portion has a second length substantially less than said first length.

3. The mounting structure as defined in claim 2 further including a tightening mechanism connected said first and second arm portions for moving said second arm portion toward said first closed position.

4. The object mounting structure as defined in claim 3 in which said first and second arm portions are provided with coaxially aligned apertures and in which said tightening mechanism comprises an elongated bolt having a threaded end, said elongated bolt being received within said coaxially aligned apertures of said first and second arm portions.

5. The object mounting structure as defined in claim 4 in which said tightening mechanism further comprises a thumbscrew threadably interconnected with said threaded end of said elongated threaded bolt.

6. The object mounting structure as defined in claim 5 in which said mounting structure comprises a mounting plate and a generally spherical shaped connector member connected to said mounting plate and extending there from, said generally spherical shaped connector member being receivable within said receiving socket for swiveling movement there within between first and second positions.

7. The mounting structure as defined in claim 6 in which said object mounting structure further comprises a pair of spaced-apart connector elements connected to said mounting plate and a connector plate interconnected with said pair of spaced-apart connector elements.

8. The object mounting structure as defined in claim 7 in which said mounting plate has an upper planar surface and in which said pair of spaced-apart connector elements protrude outwardly from said surface.

9. The object mounting structure as defined in claim 8 in which said connector plate includes a pair of spaced-apart cavities and in which each of said pair of spaced-apart connector elements comprise a central beam and a top wall portion that is interconnected with said central beam.

10. The object mounting structure as defined in claim 9 in which said connector plate includes a pair of spaced-apart cavities and in which each of said pair of spaced-apart connector elements comprises a generally “T”-shaped segment that is lockably received within said cavities formed in said connector plate.

11. The mounting structure as defined in claim 10 in which said suction forming mechanism comprises:
(a) a suction cup for engagement with a smooth surface; and
(b) a suction forming mechanism operably associated with said suction cop for causing a suction to be formed between said suction cup and said smooth surface, said suction forming mechanism comprising a housing having an axial chamber and a drive member reciprocally movable within said axial chamber, said drive member being interconnected with said suction cup.

12. The mounting structure as defined in claim 11 in which said suction forming mechanism further includes a finger engaging, pivotally mounted lever member connected to said drive member for reciprocally moving said drive member within said axial chamber of said housing.

13. A mounting structure for supporting objects within a vehicle comprising:
(a) an elongated arm assembly comprising:
(i) a unitary first arm portion having a first length and first and second ends, said first end having a generally hemispherical shaped cavity formed therein and second end including a generally cylindrically shaped connector member;
(ii) a unitary second arm portion adjustably connected to said first arm portion for movement between a first closed position and a second open position, said second arm portion having first and second ends and being of a second length substantially less than said first length, said first end having a generally hemispherical shaped cavity formed therein;
(iii) a coil spring disposed between said first and second unitary arm portions for yieldably resisting movement of said second arm portion toward said first closed position; and
(iv) a tightening mechanism connected to said first and second arm portions for moving said second arm portion toward said first closed position against the urging of said coil spring;
(b) a suction-forming connecting assembly connected to said generally cylindrically shaped connector member of said first portion of said elongated arm assembly for pivotal movement with respect thereto between a first position and a second position, said suction type connecting assembly being designed to be removably attached to a smooth surface; and
(c) an object mounting structure secured between said first and second arm portions of said elongated arms for swiveling movement with respect thereto.

14. The object mounting structure as defined in claim 13 in which said first and second arm portions are provided with coaxially aligned apertures and in which said tightening mechanism comprises an elongated bolt having a threaded end, said elongated bolt being received within said coaxially aligned apertures of said first and second arm portions.

15. The object mounting structure as defined in claim 14 in which said adjustment mechanism further comprises a thumbscrew threadably interconnected with said threaded end of said elongated threaded bolt.

16. The object mounting structure as defined in claim 15 in which said mounting structure comprises a mounting plate and a generally spherical shaped connector member connected to said mounting plate and extending there from, said generally spherical shaped connector member being receivable within said generally hemispherical shaped cavities provided in said first and second arm portions for swiveling movement there within between first and second positions.

17. The mounting structure as defined in claim 16 in which said object mounting structure further comprises a pair of spaced-apart connector elements connected to said mounting plate and a connector plate interconnected with said pair of spaced-apart connector elements.

18. A mounting structure for supporting objects within a vehicle comprising
(a) an elongated arm assembly comprising:
(i) a unitary first arm portion having a first length and first and second ends, said first end having a generally hemispherical shaped cavity formed therein and second end including a generally cylindrically shaped connector member;
(ii) a unitary second arm portion adjustably connected to said first arm portion for movement between a first closed position and a second open position, said second arm portion having first and second ends and being of a second length substantially less than said first length, said first end having a generally hemispherical shaped cavity formed therein; and
(iii) a tightening mechanism connected to said first and second arm portions for moving said second arm portion toward said first closed position against the urging of said coil spring;
(b) a suction-forming connecting assembly connected to said generally cylindrically shaped connector member of said first portion of said elongated arm assembly for pivotal movement with respect thereto between a first position and a second position, said suction type connecting assembly being designed to be removably attached to a smooth surface; and
(c) an object mounting structure secured between said first and second arm portions of said elongated arms for swiveling movement with respect thereto, said object mounting structure comprising:
(i) a mounting plate having a generally planar upper surface and a lower surface;
(ii) a pair of spaced-apart connector elements connected to generally planar surface and extending therefrom;
(iii) a generally spherical shaped connector member connected to said lower surface and extending there from, said generally spherical shaped connector member being receivable within said generally hemispherical shaped cavities provided in said first and second arm portions for swiveling movement there within between first and second positions; and
(iv) a connector plate connected to said pair of spaced-apart connector elements.

19. The object mounting structure as defined in claim 18 in which said first and second arm portions are provided with coaxially aligned apertures and in which said tightening mechanism comprises an elongated bolt having a threaded end, said elongated bolt being received within said coaxially aligned apertures of said first and second arm portions.

20. The object mounting structure as defined in claim 19 in which said adjustment mechanism further comprises a thumbscrew threadably interconnected with said threaded end of said elongated threaded bolt.
